(19) United States
(12) Patent Application Publication
(10) Pub. No.: US 2011/0134183 A1
(43) Pub. Date: Jun. 9, 2011

(54) IMPROVEMENTS IN OR RELATING TO CONTINUOUS INKJET PRINTERS

(76) Inventors: Jonathan Morgan, Cambridgeshire (GB); Bruno Sylvain Jamais, Cambridgeshire (GB)

(21) Appl. No.: 12/866,478

(22) PCT Filed: Feb. 7, 2009
(86) PCT No.: PCT/GB2009/000337

§ 371 Date: Feb. 15, 2011

(30) Foreign Application Priority Data
Feb. 8, 2008 (GB) 0802350.9

(51) Int. Cl. B41J 2/165

(52) U.S. Cl. 347/22

(57) ABSTRACT

The invention describes a gutter for incorporation in the print head of a continuous inkjet printer. The gutter, which is preferably provided with a slot entrance, is configured to reflect ink droplets which pass into the gutter off the gutter walls and towards the exit passage of the gutter. This arrangement allows the gutter to perform extremely well even when there is significant mis-alignment of the drop generator with the gutter.

### FIELD OF THE INVENTION

This invention relates to a continuous inkjet (CU) printer.

### BACKGROUND TO THE INVENTION

Continuous ink jet printing involves the formation of electrically charged drops from a jet of ink, and the subsequent deflection of the charged drops by an electric field to produce an image on a print medium. In a typical embodiment of a single-jet printer of this type, electrically conducting ink is forced through a nozzle by applying pressure to the ink. The velocity of the jet requires control, this velocity often being achieved by control of the constituency of the ink in conjunction with controlling the pressure of the ink supply. Pressure control, in turn, is usually achieved by varying the speed of the pump producing the flow, with feedback from a pressure transducer. Pressure control may also be achieved by feedback from a velocity measurement device.

A controlled sequence of drops, each with identical drop volumes and with constant separation between adjacent drops, can then be formed by modulating the jet to give active and controlled drive to the natural process of jet break up. This is usually achieved by modulating the ink pressure in a sinusoidal way, at fixed frequency and amplitude, or by modulating the ink velocity relative to the nozzle. A range of options and techniques to introduce pressure modulation, velocity modulation or a combination of both so that uniform drop sequences are obtained are known.

Those drops which are to impinge on the print medium (the print drops) have a charge induced thereon by capacitive coupling. After charging, the print drops travel through a constant electric field, whose field lines are perpendicular to the jet, and these drops are deflected by an amount that approximately scales with the charge on the drops. Unused or non-printing drops, having substantially no charge thereon, travel in a substantially straight trajectory and are collected by a gutter for ink re-flow and re-use.

A significant factor in the reliable running of a printer is in ensuring that the gutter is capable of collecting all of the non-printing drops. Non-printing drops can have a variety of subtly different trajectories due to the drop collecting small amounts of charge through cross-talk from the charge on a printed drop and also from so-called phase tests. Although methods exist to compensate for charge accumulation on non-printing drops, a residual charge remains on the drop, which is dependant to some extent on the printed pattern. In addition to this the phase drops (drops which are generated to test and establish the relationship between jet break up and drop charging) are generally charged for testing with a charge opposite in sign to the printed drops, and also need to be collected. Accordingly, the design of the ink collector or gutter must be able to clear, efficiently, a number of drops travelling at high speed and along a variety of trajectories.

The simplest design of gutter currently used is a tube of circular cross-section. This has an obvious advantage in ease of manufacture and consistency of the gutter opening. The tube is arranged with the plane of the open face of the tube perpendicular to the incoming ink droplet stream. The tube then turns through 90° via a shallow curve, the curve being configured to minimize the reduction in jet speed and thus allow the momentum of the jet to aid the clearing-away of the ink. The disadvantage with this design is that it is difficult to align the jet relative to the circular edge of the tube. The distance between the least deflected printing droplet and the gutter edge has a critical impact on reliability for a continuous inkjet printer as variations in pressure, temperature and viscosity have subtle effects on the trajectory of the least deflected drop. If this distance between gutter and droplet becomes too small then the droplet impacts with the edge of the gutter and, over time, degrades print quality as the dried ink build-up on the gutter regularly interferes with the drop intended for the least deflected printing position.

One attempt to ease the alignment problem outlined above is to drill a hole in a block of suitable material. This method of production uses the drilling process to place the straight edge of the block tangentially to the hole. This effectively sets a tube against a straight edge, and the jet is aligned relative to the straight edge, and the centre line of the hole. This method represents an improvement but still requires careful alignment of the jet along two axes.

The problems outlined above have, at least to some extent, been addressed in the prior art. British Patent Application GB 2,118,103 describes a gutter formed from materials of different surface energy. Drops entering the gutter impact a surface coated with a low surface energy material and are caused to ‘slide’ along the surface away from the impact area.

U.S. Pat. 4,890,119 describes a catcher or gutter geometry which addresses the alignment issue by incorporating an elongated entrance aperture. However, within the catcher, the impact surface is, in the manner of conventional catchers, concave in form and thus serves to take momentum from the incoming droplets. After impact the droplets are said to flow under gravity to a reservoir portion within the catcher.

Japanese Publication JP 56064874 shows a variation of the conventional circular gutter aperture in which the section of the circle closest to the path of the printed drops is flattened. The collection path is otherwise conventional and configured so as to reduce the momentum of the collected drops.

British Patent GB 1448 098 describes a multi-jet inkjet printer having an elongated catcher to catch unprinted drops. Drops which are not to be printed are directed to impact a convex outer surface of the assembly defining the catcher. The convex outer surface is configured to prevent the drops splattering upon impact but remove the momentum from the drops so that they attach to the surface and flow down the surface. A blade projects outwardly adjacent the lower edge of the convex surface to ingest the captured drops which are then drawn through collection apertures, and into the interior of the catcher, by vacuum.

It is an object of this invention to provide apparatus and/or methods which go at least some way to addressing the problems described above; or which will at least provide a novel and useful alternative.

### SUMMARY OF THE INVENTION

Accordingly, in one aspect, the invention provides a gutter for a continuous inkjet printer, said gutter having an entrance aperture; an exit passage; and a wall section extending between said entrance aperture and said exit passage, said gutter being characterised in that said wall section is configured and arranged, at least in part, to reflect ink droplets incident thereon towards said exit passage.

Preferably said entrance aperture comprises a slot having substantially parallel longer edges linked at each end by shorter edges.

Preferably those parts of the wall section extending from said shorter edges taper towards said exit passage.

Preferably those parts of the wall section extending from said shorter edges have a convex profile.

In a second aspect the invention provides a continuous inkjet printer including a gutter set forth above.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

The various aspects of the invention will now be described with reference to the accompanying drawings in which:

FIG. 1: shows a plan view of a CIJ printer gutter according to the Invention;

FIG. 2: shows a view along the line A-A in FIG. 1;

FIG. 3: shows a view along the line B-B in FIG. 2;

FIG. 4: shows a comparison of the clearance characteristics of a gutter according to the invention and gutters having straight and concave internal walls; and

FIG. 5: shows a comparison of the clearance properties of a gutter according to the invention and those of a gutter comprising a simple slot.

### DETAILED DESCRIPTION OF WORKING EMBODIMENT

As a consequence of the variety of trajectories possible for non-printing drops emanating from the droplet generator of a CIJ printer, it is common practice to adjust the ink stream into a precise point within the gutter. This invention describes a gutter having a slotted entry aperture and carefully designed inner profile which, as a result, is able to clear ink effectively, and independently of the position of the ink stream within it, along the long axis of the slot. This, in turn, facilitates the alignment of the print head by removing one axis of adjustment, and also allows the optimum jet position to be chosen for effective discrimination between non-printed drops, and the least deflected printed drop, without having to pay attention to gutter clearance issues.

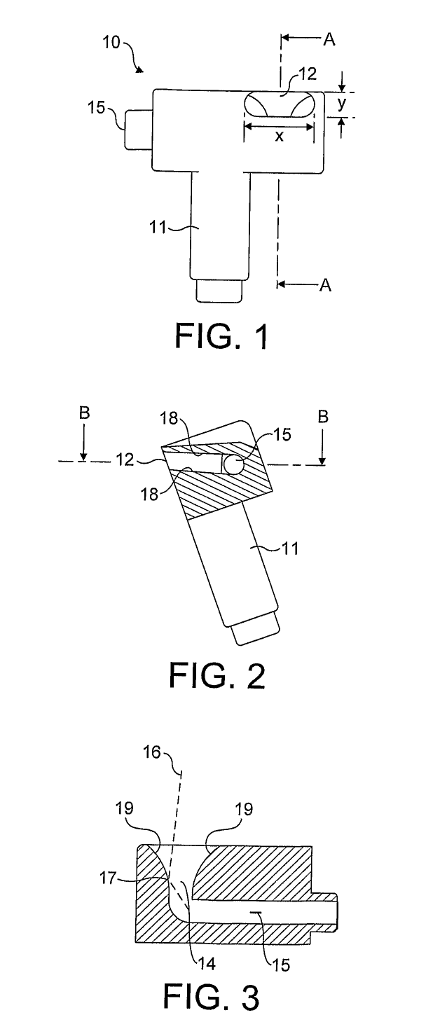

Referring to FIGS. 1 to 3, a gutter 10 is provided for use with a continuous inkjet printer. The printer is not shown in the drawings being well known to those skilled in the art. The gutter 10 is positioned, conventionally, on the exit edge of the print head and, in the case of the embodiment shown, by means of mounting column 11.

The gutter 10 includes an entrance aperture 12 through which un-deflected ink droplets pass into the gutter. As can be seen, the aperture 12 preferably comprises a slot having width x and depth y. A continuous wall 14 extends internally and rearwardly from the aperture 12 and converges into exit passage 15. In use, the exit passage is connected to a vacuum line which directs the ink collected in the gutter, back to the ink system of the printer for recirculation in the known manner.

According to the invention; the internal geometry of the wall 14 is configured and arranged, at least in part, to reflect ink droplets incident thereon towards the exit passage 15. Preferably, as is illustrated in FIG. 3, the normal of the internal surface bisects the angle formed between the jet 16 and the point of contact 17 of the jet with the gutter and the axis of the exit passage 15. Arranging the internal geometry in this way yields an unexpected result in that the internals of the gutter are convex with respect to an observer who is looking into the slot from the aperture 12 as is apparent from FIG. 1. This is in contrast to the concave impact surfaces shown in the prior art.

Given the slot form of the entrance aperture 12, the wall 14 is defined by facing side walls 18 and facing end walls 19. In the embodiment shown in the drawings, only the end walls 19 are provided with a convex profile. Although it is preferable for the walls 18 also to be convex relative to the jet, common manufacturing techniques such as metal injection moulding do not permit the preferred geometry as it is not possible to insert and withdraw a pin and form such a complex shape. Nevertheless the compromise disclosed still exhibits a noticeable advance in performance over the prior art and, in particular, renders gutter clearance independent of alignment along the axis x of the gutter.

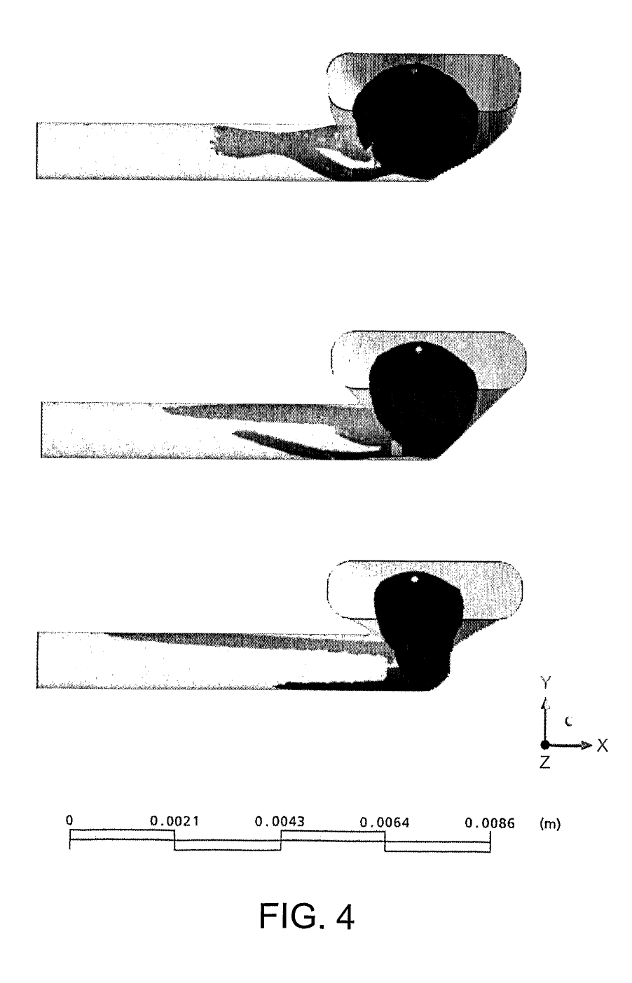

FIG. 4 illustrates the performance of a variety of internal gutter geometries. Clearance performance is judged by calculating the surface contact area of the fluid with the gutter walls. A wide spread of the collected ink indicates less efficient clearing whilst a narrow spread of the collected ink indicates more efficient clearing. As can clearly be seen in FIG. 4, the modelling and experimental results show that a convex gutter in accordance with the invention (the bottom illustration in FIG. 4) clears ink more effectively than a gutter with concave walls (the top illustration) or straight walls (the middle illustration). The concave gutter attempts to reproduce the internals of a tube gutter, within a slot geometry, by steering the momentum of the jet along the bottom of the gutter, the depth of the gutter wall section preventing overflow of excess fluid. Experimentally it is observed that the concave gutter periodically fills with fluid resulting in a pulsed removal of fluid. When the gutter is filled with ink, the impinging ink stream bounces off the surface of the fluid pool in the gutter, causing an overflow in some circumstances, and an undesirable result. The straight edged gutter represents a manufacturing compromise, such that the angle of the side edges is selected to be as dose as possible to fulfilling the requirement that the normal of the edge surfaces bisects the angle formed between the jet and the line defined by the point contact of the jet impinging on the surface and the axis of the exit passage.

A tolerance analysis of possible jet positions, without jet alignment in the x axis of the gutter as shown in FIG. 1, reveals that for a state of the art nozzle, (e.g. a nozzle manufactured using a method such as that described in our pending European Patent Application No. 1 871 607) reveals that the jet can be in a position that is within±1 mm. due to a combination of jet run-out and mechanical tolerances. An investigation has therefore been performed which analyses and compares the behaviour of a simple slotted gutter and a gutter formed in accordance with the invention and having the preferred convex end walls. In both cases modelling is undertaken with the jet offset by 1 mm either side of the slot centre line. The funnel profile is arguably symmetrical but, because the suction port is on one side, we have performed calculations for both sides of jet offset.

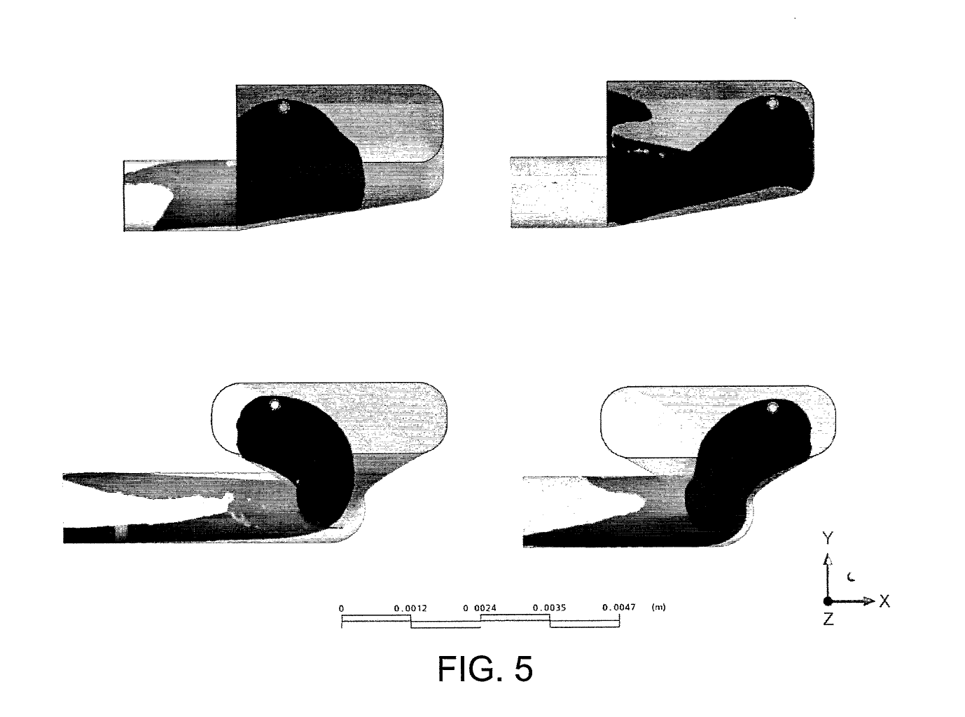

FIG. 5 shows the results obtained, which have been demonstrated experimentally. The simple slot gutter is illustrated at the top of FIG. 5. while the two views of the gutter incorporating the invention, appear below. It is clear that while a simple slot gutter is predicted to cope well with an offset of the jet towards the suction bore (left view), it is found to behave inadequately in case of a maximum offset at the opposite edge side. The funnel profile shows a substantially symmetrical behaviour either side of the ideal jet position and, with either offset, its clearance behaviour is superior to that of the simple slotted gutter:

The preferred embodiment shows a convex walled gutter that it is possible to manufacture, using suitable tooling, by a method such as metal injection moulding. An alternative embodiment is to use tapering straight edges such, that the angle of the edge is selected to be as close as possible to fulfilling the requirement that the normal of the surface bisects the angle formed between the jet and the line defined by the point contact of the jet impinging on the surface and the bore of the removal tube.

As a further alternative, continuous ink jet printers with multiple jets are well known in the art. One alternative embodiment of the convex walled gutter is to arrange an array of convex walled cavities so that the centre of each cavity is aligned with each jet and the gutter is arranged as one large slot, which is aligned in the direction of the array of ink jets. This arrangement would allow for a single gutter exit passage to be used at the bottom of the gutter, with several distinct cavities in the structure above.

It will thus be appreciated that the invention, at least in the case of the embodiment thereof described herein, has the advantage that unprinted ink drops can be collected in the gutter even though there may be significant mis-alignment of the droplet generator.

1. A gutter for a continuous inkjet printer, said gutter comprising: an entrance aperture; an exit passage; and a wall section extending between said entrance aperture and said exit passage, wherein said wall section is configured and arranged, at least in part, to reflect ink droplets incident thereon toward said exit passage.

2. A gutter as claimed in claim I wherein said entrance aperture comprises a slot having substantially parallel longer edges linked at each end by shorter edges.

3. A gutter as claimed in claim 2 wherein those parts of the wall section extending from said shorter edges taper towards said exit passage.

4. A gutter as claimed in claim 2 wherein those parts of the wall section extending from said shorter edges have a convex profile.

5. A continuous inkjet printer including a gutter as claimed in claim 1.
